(19) United States
(12) Patent Application Publication
(10) Pub. No.: US 2008/0285007 A1
(43) Pub. Date: Nov. 20, 2008

(54) SYSTEM AND METHOD FOR MEASUREMENT OF THICKNESS OF THIN FILMS

(76) Inventor: Michael K. Hughes, Vancouver (CA)

Correspondence Address: HONEYWELL INTERNATIONAL INC., 101 COLUMBIA ROAD, P O BOX 2245, MORRISTOWN, NJ, 07962-2245, US

(21) Appl. No.: 12/181,101

(22) Filed: Jul. 28, 2008

Related U.S. Application Data
(62) Division of application No. 11/646,221, filed on Dec. 27, 2006.

(51) Int. Cl. G01C 3/08

(52) U.S. Cl. 356/4.04

(57) ABSTRACT

A measurement system that uses a laser triangulation device to measure the thickness of transparent and/or opaque layers of a multilayer film. The triangulation device has a laser device that projects a beam perpendicularly to a surface of the multilayer film and first and second detectors that image first and second reflected rays of the beam at first and second distances offset from first and second optical axes to produce first and second measurement signals. A controller processes the measurement signals using a triangulation procedure and a simultaneous equation procedure to provide a thickness of an outer transparent layer. For a multilayer film having an opaque layer sandwiched between outer transparent layers, first and second triangulation devices are disposed on opposed sides of the film to measure the thickness of each outer film. Knowing the distance between the two devices, the thickness of the opaque layer can be derived.

### CROSS-REFERENCED APPLICATIONS

This application is a Divisional application of U.S. patent application Ser. No. 11/646,221, filed on Dec. 27, 2006, which is incorporated herein in its entirety.

### FIELD OF THE INVENTION

This invention relates to a system and method for the measurement of the thickness of thin films.

### BACKGROUND OF THE INVENTION

Often plastics manufacturers will produce layered plastic films which have as the outside layers a clear or transparent film on top of an opaque film. The manufacturer would like to be able to measure the thickness of either or both of the films. If a specular reflection can be seen from the clear/opaque interface then it is possible to measure the thickness with interferometric techniques or by the separation between two reflected beams. If the specular reflection cannot be seen, there is currently no way to measure the thickness.

There is a need for a measurement system that can measure thickness of the clear film and/or the opaque film whether or not the specular image is visible from the clear/opaque interface.

### SUMMARY OF THE INVENTION

A system for the measurement of a thickness of a layer of a multilayer film comprises a laser that provides a beam to a surface of the multilayer film. A detector images first and second reflected rays of the beam at first and second distances that are offset from first and second optical axes, respectively, and produces first and second signals based on the first and second offset distances, respectively. A controller processes the first and second signals to provide the thickness of the layer to an output device.

In one embodiment of the system of the present invention, the first and second reflected rays are at first and second angles to a normal of the surface.

In another embodiment of the system of the present invention, the layer is transparent and is disposed on an opaque layer of the multilayer film. The first and second reflected rays are reflected from the opaque layer.

In another embodiment of the system of the present invention, the detector further comprises first and second lenses that are centered on the first and second optical axes, respectively, and are located at first and second distances from the laser.

In another embodiment of the system of the present invention, the detector further comprises first and second position sensitive devices that coact with the first and second optical lenses, respectively. The first and second position sensitive devices produce the first and second signals, respectively.

In another embodiment of the system of the present invention, the laser and the detector are packaged in a scanner head that scans across the multilayer film.

In another embodiment of the system of the present invention, the controller uses a triangulation procedure that produces first and second equations based on the first and second offset distances, respectively, and uses a simultaneous equation procedure based on the first and second equations to provide the thickness of the layer.

In another embodiment of the system of the present invention, the layer is a transparent plastic and is disposed on an opaque layer of the multilayer film. The first and second reflected rays are reflected from the opaque layer. The triangulation procedure uses the following to produce the first equation:

nₚ sin φ=nₐ sin φ′,
where φ is an angle between the first reflected ray and the opaque layer and φ′ is an angle between the first reflected ray the transparent layer, nₚ and nₐ are refractive indices of plastic and air respectively,

x=t·tan φ+d·tan φ′,
where x is the first distance and t is the thickness,

y=z·tan δ,
where y is the first offset distance, z is a distance between the first optical lens and the first position sensitive detector and δ is an angle between the first reflected ray and the first optical axis,

θ=δ+φ′,

where θ is an angle between the first optical axis and the normal, and wherein the triangulation procedure similarly produces the second equation.

In another embodiment of the system of the present invention, the layer is a first transparent layer. The multilayer film further comprises a second transparent layer. The first and second transparent layers are disposed on opposite surfaces of the opaque layer. The laser and detector comprise a first device that is substantially identical to a second device. The first and second devices are disposed on opposite sides of the multilayer film to measure a first thickness of the first transparent layer and a second thickness of the second transparent layer. The controller uses the first thickness and second thickness to determine a third thickness of the opaque layer.

A method of the present invention measures a thickness of a layer of a multilayer film. The method comprises providing a beam from a laser to a surface of the multilayer film, imaging first and second reflected rays of the beam at first and second distances that are offset from first and second optical axes, respectively, producing first and second signals based on the first and second offset distances, respectively, and using a controller that processes the first and second signals to provide the thickness of the layer to an output device.

In one embodiment of the method of the present invention, the first and second reflected rays are at first and second angles to a normal of the surface.

In another embodiment of the method of the present invention, the layer is transparent and is disposed on an opaque layer of the multilayer film. The first and second reflected rays are reflected from the opaque layer.

In another embodiment of the method of the present invention, the imaging step uses first and second lenses that are centered on the first and second optical axes, respectively, and that are located at first and second distances from the laser.

In another embodiment of the method of the present invention, the imaging step further uses first and second position sensitive devices that coact with the first and second optical lenses, respectively. The first and second position sensitive devices produce the first and second signals, respectively.

In another embodiment of the method of the present invention, the controller uses a triangulation procedure that produces first and second equations based on the first and second offset distances, respectively, and uses a simultaneous equation procedure based on the first and second equations to provide the thickness of the layer.

In another embodiment of the method of the present invention, the layer is a transparent plastic and is disposed on an opaque layer of the multilayer film. The first and second reflected rays are reflected from the opaque layer. The triangulation procedure uses the following to produce the first equation:

nₚ sin φ=nₐ sin φ′,
where φ is an angle between the first reflected ray and the opaque layer and φ′ is an angle between the first reflected ray the transparent layer, nₚ and nₐ are refractive indices of plastic and air respectively,

x=t·tan φ+d·tan φ′,
where x is the first distance and t is the thickness,

y=z·tan δ,

where y is the first offset distance, z is a distance between the first optical lens and the first position sensitive detector and δ is an angle between the first reflected ray and the first optical axis,

θ=δ+φ′,

where θ is an angle between the first optical axis and the normal, and wherein the triangulation procedure similarly produces the second equation.

In another embodiment of the method of the present invention, the layer is a first transparent layer. The multilayer film further comprises a second transparent layer. The first and second transparent layers are disposed on opposite surfaces of the opaque layer. The providing step also provides a second beam to a surface of the second transparent layer. The imaging step also images third and fourth reflected rays of the second beam at third and fourth distances that are offset from third and fourth optical axes, respectively. The producing step also produces third and fourth signals based on the third and fourth offset distances, respectively. The using step uses the controller to process the third and fourth signals to provide a thickness of the second transparent layer and uses the thickness of the first transparent layer and the thickness of the second transparent layer to provide a thickness of the opaque layer.

A scanning head of the present invention scans a multilayer film to measure a thickness of a layer of the multilayer film. The scanner head comprises a laser, first and second lenses and first and second position sensitive devices. The first and second lenses are disposed at first and second distances from the laser. The first lens and the first position sensing device are centered a first optical axis. The second lens and the second positioning device are centered a second optical axis.

In one embodiment of the scanner head, the first and second lenses are oriented at first and second different angles, respectively, with respect to a direction of a beam emitted by the laser.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a diagram of a measurement system of the present invention;

FIG. 2 is a diagram of one of the detectors of the measurement system of FIG. 1; and

FIG. 3 is a diagram of another embodiment of the measurement system of the present invention.

### DESCRIPTION OF THE PREFERRED EMBODIMENT

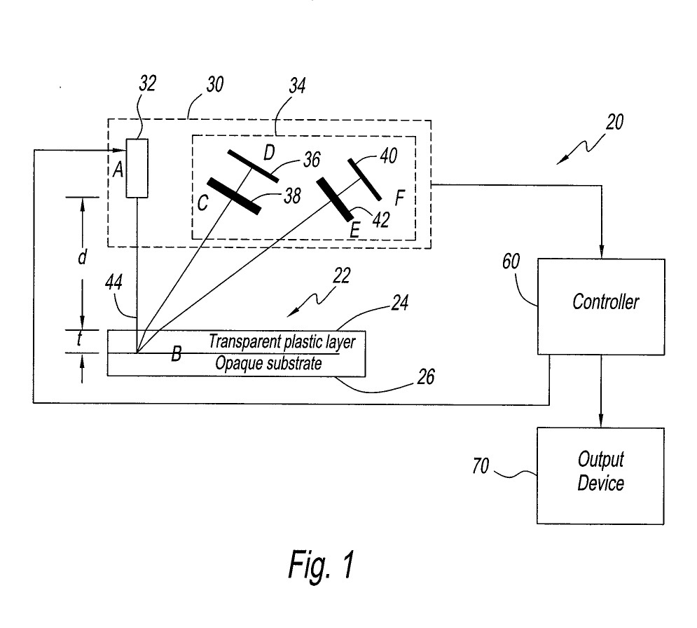

Referring to FIG. 1, a measurement system 20 of the present invention measures a thickness of a multilayer plastic film 22, which comprises a transparent layer 24 disposed on an opaque layer or substrate 26. In particular measurement system 20 measures a thickness t of transparent layer 24.

Measurement system 20 comprises a laser triangulation device 30, a controller 60 and an output device 70. Laser triangulation device 30 comprises a laser 32 and a detector 34. Detector 34 comprises a position sensitive device 36, a lens 38, a position sensitive device 40 and a lens 42.

Controller 60 may be any suitable machine that has calculating capability. For example, controller 60 may be a personal computer, a workstation, a PDA or other calculating machine. The calculating capability can be provided by a program stored in a memory of controller 60. Output device 70 may suitably be a display device or a printer that can provide the value of t to a user.

Controller 60 is operable to cause laser 32 to project a beam 44 onto plastic film 22. Beam 44 is passed by transparent layer 24 so as to form a spot at the interface of transparent layer 24 and opaque layer 26. Position sensitive device 36 and lens 38 are set along an optical axis (OA) at a known angle to beam 44. Similarly, position sensitive device 40 and lens 42 are set along a different OA at a known different angle to beam 44. The spot is imaged by lenses 38 and 42 onto position sensitive device 36 and 40, respectively. From the locations of the images on position sensitive devices 36 and 40, controller 60 calculates a value for thickness t and provides the value to output device 70. Each image location is offset from the respective OA by a distance y. The respective distances y are detected and outputted as first and second measurement signals from position sensitive device 36 and 40 to controller 60. Position sensitive devices 36 and 40, for example, may each be a 47-48 DuoLat device available from Osioptoelectronics.

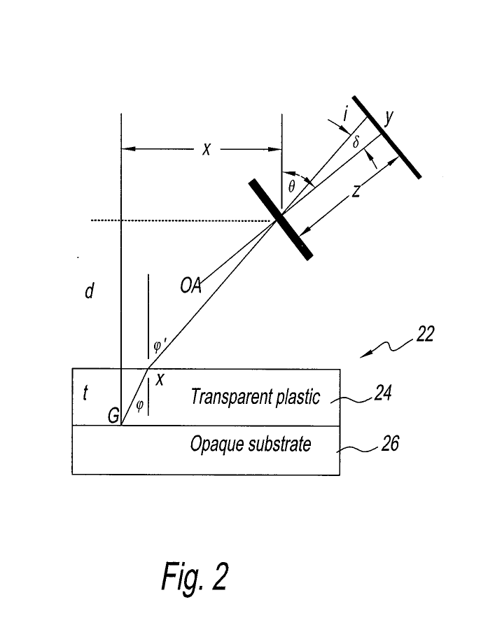

To demonstrate the calculation, just the projected beam 44 and one position sensitive device 36 and lens 38 are shown in FIG. 2. Beam 44 is incident perpendicularly on plastic film 22 and forms a spot on opaque substrate 26 at a point G (the reflection from G is diffuse). A ray HI that determines where the image will be formed on position sensitive device 36 goes through the center of lens 38 without deflection (ideal lens approximation—this can easily be generalized to real lenses). Ray HI is imaged on position sensitive device 36, centered at a distance y from the OA. The OA of imaging lens 38 is defined as being perpendicular to lens 38 and through its center. The angle between projected beam 44 and the OA is θ. The angle between HI and the OA is δ. The focal length of lens 38 is chosen such that a point near the middle of the desired working range is imaged onto position sensitive device 36. Small deviations from this distance result in a slightly smeared image on the position sensitive device. However, that is permissible since the important parameter is the intensity-weighted center of the imaged light spot that does not change.

It will be demonstrated that with two position sensitive devices 36 and 40, the values for d and t can be calculated, where d is the distance between the center of lens 38 and the interface of opaque layer 26 and transparent layer 24. The distance d may be the same or different for lenses 38 and 42. If d is the same, the calculations will be simplified.

It is known from Snell's law that

nₚ sin φ=nₐ sin φ′, Equation 1

where φ and φ′ are defined in FIG. 2 and nₚ and nₐ are the refractive indices of plastic and air respectively. It can easily be seen that a fixed distance x determines φ and φ′ for a given t and d and given Equation 1.

x=t·tan φ+d·tan φ′. Equation 2

Simple trigonometric manipulation shows that y=z·tan δ. Also, θ=δ+φ′. The reflected image of G on position sensitive device 36 is at a location y that is offset from the OA. Arbitrarily assuming that y=0 at the intersection of position sensitive device 36 with the OA and given the measured value of y, φ can be calculated from equation 1. There are then only two unknowns t and d. The same calculations are performed for position sensitive detector 40 with the result of again leaving two unknowns, t and d. Given equations 1 and 2 for both position sensitive detectors 36 and 40, the values for t and d can be calculated using a simultaneous equations calculation. Thus, controller 60 uses a triangulation procedure to convert the two distance values of y to two equations, each having two unknowns t and d, and then uses a simultaneous equation procedure to determine the values of t and d.

As an example of the above procedure, a transparent layer 5.0 microns thick is placed 25 millimeters (mm) from position sensitive device 36 (assuming that the laser output is the same distance from the sheet as are the two imaging lenses). Therefore, d=25 mm. For this example, the OA of position sensitive device 36 and lens 38 is 30° to the sheet normal and the OA of position sensitive device 40 and lens 42 is 45° to the sheet normal. Also, nₚ is 1.30 and nₐ is 1.00. Using these values and the preceding equations, y is 1.25 μm for position sensitive device 38 and 1.30 μm for position sensitive device 40. If we then measure a layer that is 5.2-μm thick we find corresponding values of y that are 1.30 μm and 1.35 μm for position sensitive devices 38 and 40, respectively—shifts of 0.05 μm in each case. These may seem like small changes but they must be compared to the resolution of commercially available detectors. A resolution of 0.1 μm at a range of 25 mm is not uncommon. With the same value for z (again the exact value is unimportant), the shift in y is 0.03 and 0.04 μm for detectors a and b respectively. Therefore, it should be possible to resolve 0.2 μm changes in the transparent plastic layer.

Preferably, laser triangulation device 30 is packaged in a scanner head that scans across multilayer film 22, which, e.g., may be a web of plastic or plastic coated paper that is moved in a machine direction perpendicular to the drawing sheet of FIG. 1. The scanner head is operated to scan back and forth across multilayer film 22 from left to right, right to left and so on. Controller 60 operates laser beam 44 at several locations during a scan to obtain several measurement samples. Controller 60 can then consolidate the samples in a predetermined format that can be outputted to output device 70.

In order to maintain multilayer film 22 within a range of laser triangulation device 30, an air clamp (not shown) can be used. An example of a suitable air clamp is disclosed in U.S. Pat. No. 6,936,137. The air clamp uses air to stabilize multilayer film 22 as the scanner head scans across it. Alternative technologies, such as rollers, can also be used.

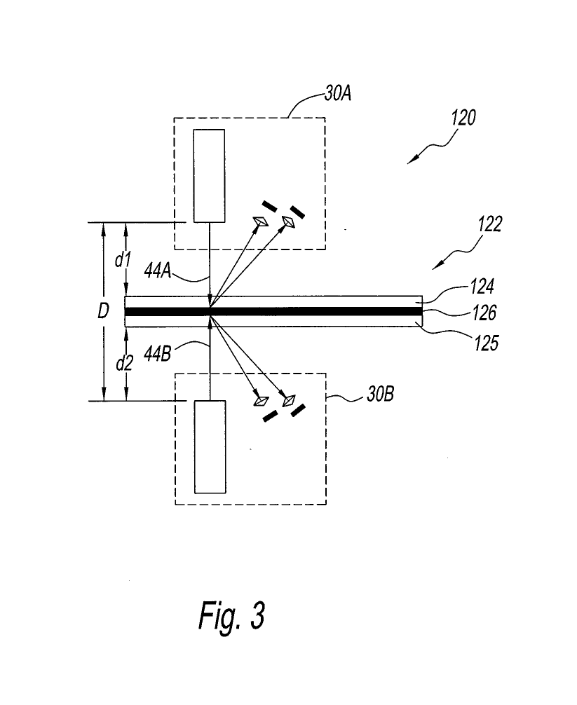

Referring to FIG. 3, a measurement system 120 is used to measure properties of opaque materials with outer transparent layers. Namely, the thickness of an opaque layer can be measured as well as the thickness of the outer transparent layers. Measurement system 120 comprises first and second triangulation devices 30A and 30B disposed on opposed sides (above and below in FIG. 3) of a multilayer film 122. Multilayer film 122 comprises a transparent layer 124 and a transparent layer 125 disposed on opposite surfaces of an opaque layer 126. Laser triangulation devices 30A and 30B are substantially identical to laser triangulation device 30 of FIGS. 1 and 2 and, therefore, bear the same reference numeral with a suffix A or B. Laser triangulation devices 30A and 30B are interconnected with controller 60 and output device 70 as shown in FIGS. 1 and 2, but not in FIG. 3.

Laser beams 44A and 44B are projected at spots on opposite sides of multilayer film 122. Laser beams 44A and 44B are projected such that the spots are at the same transverse position on multilayer film 122 so as to measure the thickness of transparent layers 124 and 125 and of opaque layer 126 as well at that point. Then, using the measurements described above for measurement system 20, the thickness of transparent layers 124 and 125 and the distances d1 and d2 from the lasers 32A and 32B to the outer surfaces of transparent layers 124 and 125 can be derived. Knowing the distance D between laser triangulation devices 30A and 30B, the total thickness of multilayer film 122 and the thickness of the opaque layer 126 (D−d1−d2=thickness) can be derived.

The distance D between the two devices can be derived from measurements of an inductive distance sensor (not shown). This is commonly done for such measurements. The inductive sensor is insensitive to non-conductive and non-magnetic webs such as is common in plastics applications. In order to avoid interference between laser triangulation devices 30A and 30B caused by light transmitted through opaque (or partially opaque) layer 126, it may be necessary to operate laser triangulation devices 30A and 30B in a pulsed mode with different frequencies and frequency discriminating measurement. Alternatively, laser triangulation devices 30A and 30B can be operated at different light wavelengths with optical filters such that the detectors see only the relevant wavelengths.

The present invention having been thus described with particular reference to the preferred forms thereof, it will be obvious that various changes and modifications may be made therein without departing from the spirit and scope of the present invention as defined in the appended claims.

What is claimed is:

1. A scanner head that scans a multilayer film to measure a thickness of a layer of said multilayer film, said scanner head comprising:
a laser, first and second lenses and first and second position sensitive devices, wherein said first and second lenses are disposed at first and second distances from said laser, wherein said first lens and said first position sensing device are centered a first optical axis, and wherein said second lens and said second positioning device are centered a second optical axis.

2. The scanner head of claim 1, wherein said first and second lenses are oriented at first and second different angles, respectively, with respect to a direction of a beam emitted by said laser.
